(19) United States
(12) Patent Application Publication
(10) Pub. No.: US 2025/0036449 A1
(43) Pub. Date: Jan. 30, 2025

(54) TOKEN-LESS AND KEY-VALUE MAPPING VIRTUAL MACHINES

(71) Applicant: Ava Labs, Inc., New York, NY (US)

(72) Inventors: Stephen John BUTTOLPH, Brooklyn, NY (US); Patrick Robert O'GRADY, Palo Alto, CA (US)

(73) Assignee: Ava Labs, Inc., New York, NY (US)

(21) Appl. No.: 18/715,898

(22) PCT Filed: Dec. 2, 2022
(86) PCT No.: PCT/US2022/051650

§ 371 Date: Jun. 3, 2024

Related U.S. Application Data
(60) Provisional application No. 63/285,906, filed on Dec. 3, 2021.

(51) Int. Cl. G06F 9/455; H04L 9/00

(52) U.S. Cl. CPC G06F 9/45558; H04L 9/50; G06F 2009/45587

(57) ABSTRACT

A method for operating virtual machines in a blockchain network is provided. The method includes requesting, by an agent, a recent block hash to use for transaction construction and a target complexity to mine, constructing, by the agent, a transaction comprising at least a public key and/or a virtual machine transaction, and periodically creating, by a block producer, a block comprising a set of transactions that surpass a minimum complexity. A system including a memory storing instructions and a processor configured to execute the instructions to cause the system to perform the above method is also provided.

### CROSS-REFERENCE TO RELATED APPLICATIONS

The present disclosure is related and claims priority under 35 U.S.C. § 119 (e) to U.S. Prov. Appln. No. 63/285,906, entitled TOKEN-LESS AND KEY-VALUE MAPPING VIRTUAL MACHINES, to Patrick R. O'GRADY, filed on Dec. 3, 2021, the contents of which are hereby incorporated by reference in their entirety, for all purposes.

### BACKGROUND

### Field

The present disclosure is related to conducting transactions on any type of blockchain networks, which may include any number of distinct virtual machines that uniquely govern the logic of state transitions. More specifically, the present disclosure is directed to a token-less strategy for conducting transactions using key-mapping hierarchies in a blockchain network.

### Related Art

Current blockchain applications impose severe restrictions to create sub-networks, lacking reward mechanisms, and cross-subnet transfer mechanisms. Users are therefore unable to incorporate a new virtual machine into their own sub-network. Managing native/fee tokens across multiple networks is a complex task that becomes a barrier for adopting new technologies.

### SUMMARY

In a first embodiment, a computer-implemented method includes requesting, by an agent, a recent block hash to use for transaction construction and a target complexity to mine, constructing, by the agent, a transaction comprising at least a public key and/or a virtual machine transaction, and periodically creating, by a block producer, a block comprising a set of transactions that surpass a minimum complexity.

In a second embodiment, a system includes a memory storing multiple instructions, and one or more processors configured to execute the instructions to cause the system to perform a process. The process includes to request, by an agent, a recent block hash to use for transaction construction and a target complexity to mine, to construct, by the agent, a transaction comprising at least a public key and/or a virtual machine transaction, to periodically create, by a block producer, a block comprising a set of transactions that surpass a minimum complexity, and to serially process state transitions in valid blocks.

In a second embodiment, a system includes a memory storing multiple instructions, and one or more processors configured to execute the instructions to cause the system to perform a process. The process includes to request, by an agent, a recent block hash to use for transaction construction and a target complexity to mine, to construct, by the agent, a transaction comprising at least a public key and/or a virtual machine transaction, to periodically create, by a block producer, a block comprising a set of transactions that surpass a minimum complexity, and to serially process state transitions in valid blocks.

In a third embodiment, a non-transitory computer-readable medium that stores instructions which, when executed by one or more processors, cause a computer to perform a method, the method includes requesting, by an agent, a recent block hash to use for transaction construction and a target complexity to mine, constructing, by the agent, a transaction comprising at least a public key and/or a virtual machine transaction, and periodically creating, by a block producer, a block comprising a set of transactions that surpass a minimum complexity.

In yet other embodiments, a system includes a first means to store instructions, and a second means to execute the instructions to cause the system to perform a method. The method includes requesting, by an agent, a recent block hash to use for transaction construction and a target complexity to mine, constructing, by the agent, a transaction comprising at least a public key and/or a virtual machine transaction, and periodically creating, by a block producer, a block comprising a set of transactions that surpass a minimum complexity.

These and other embodiments will become clear to one of ordinary skill in the art in light of the following.

### BRIEF DESCRIPTION OF THE FIGURES

FIG. 1 illustrates a network architecture for implementing a token-less and key-value mapping virtual machine, according to some embodiments.

FIG. 2 illustrates a block diagram including some of the devices and systems used in the architecture of FIG. 1, according to some embodiments.

FIG. 3 is a flow chart illustrating steps in a method for implementing a key-value mapping virtual machine, according to some embodiments.

FIG. 4 is a flow chart illustrating steps in a method for implementing a token-less and key-value mapping virtual machine, according to some embodiments.

FIG. 5 illustrates a computer system configured to perform at least partially some of the steps in the method of FIGS. 3 and 4, according to some embodiments.

In the figures, elements having the same or similar reference numeral are associated with the same or similar attributes or features, unless explicitly stated otherwise.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included claims. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

### General Overview

Aspects of the present disclosure are directed to fee-less virtual machine (VM) transactions. Additional aspects of the present disclosure include key-value VMs (with hierarchical key ownership controls). For example, a key has the “right” to modify child (e.g., derived) keys. Additional aspects of the present disclosure include a novel token-less VM. It is understood that these are exemplary only, and additional embodiments are included.

In current blockchain networks, it is desirable to create sub-networks for increasing network capabilities, quality of service, speed, and the like. However, current systems have severe restrictions for growth (they lack reward mechanisms and appropriate cross-subnet transfer schemes). Typically, developers are unable to implement virtual address extension (VAX) machines into their own sub-network.

Embodiments as disclosed herein provide virtual machine extensions that support blockchain networks and state changes. This disclosure includes a key-value virtual mapping (KVVM) that is a simple, standalone but useful platform for VM implementation in blockchain networks.

Current approaches that use interplanetary file systems (IPFS) support decentralized, structured file storage, but the data/directory structure is weak, and current best-efforts offer no guarantee that every node preserves (e.g., “replicates”) the data (e.g., only if their operators “choose” to store them). Thus, IPFS offers only eventual consistency regarding the state of the stored data. Other systems provide strong consistency and similar prefixed storage, but are heavily centralized (only crash fault tolerant) and do not scale as it would be desirable.

Embodiments disclosed herein resolve the above technical problems by having every node, or almost every node, preserve a strongly consistent view of all mappings and its modification history (with the exception of Byzantine nodes that deviate from the protocol). Additionally, KVVM implementations may use any byte string as a key/value, simplifying its universal adoption by users.

Typically, blockchain networks include a long, complex process to “purchase” tokens. To simplify blockchain transactions, the present disclosure includes Proof-of-Work (PoW) operations within a local CPU without requiring any intermediaries.

Most applications require a centralized database to track active user state. To avoid bottlenecks and server overload, embodiments as disclosed herein implement decentralized data storage and key verification. Embodiments as disclosed herein avoid the need to bring tokens to a network before being able to use it, thus enabling people to adopt new networks/technology more rapidly.

### Example System Architecture

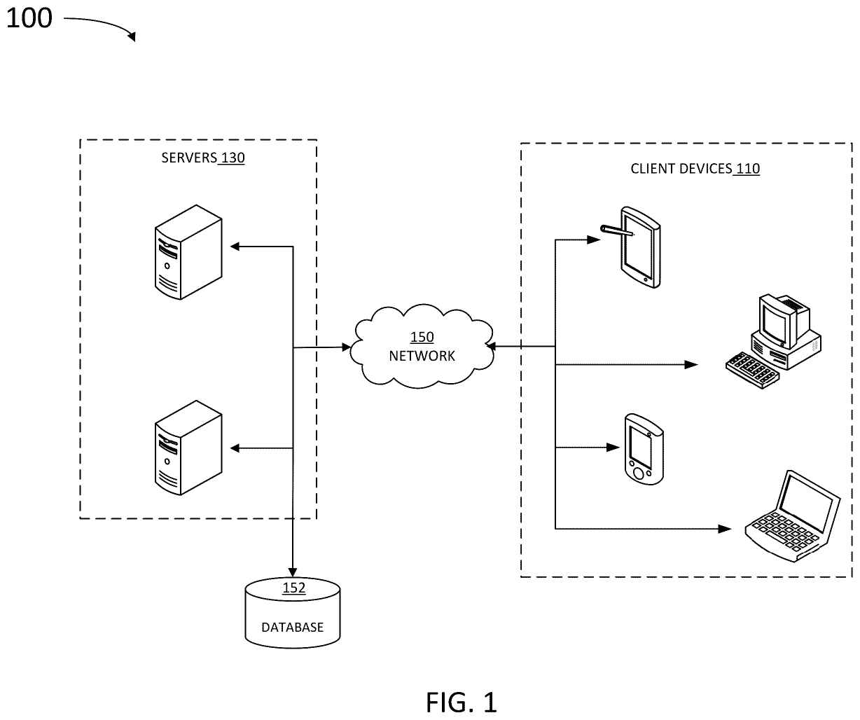

FIG. 1 illustrates a network architecture 100 for implementing a token-less and key-value mapping virtual machine, according to some embodiments. Servers 130 and a database 152 are communicatively coupled with client devices 110 via a network 150. Servers 130 may host an application running in client devices 110. Client devices 110 may be used by participants in the applications. Client devices 110 may include smart phones, laptops, mobile devices, palm devices, and even desktops. In some embodiments, the applications may include transactions such as smart contract negotiation and execution, and the like. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like. Database 152 may store backup files from the chat conversations, including threads, messages, videos, and metadata. In addition, database 152 may include encrypted keys that may be distributed to each and all of the chat group participants.

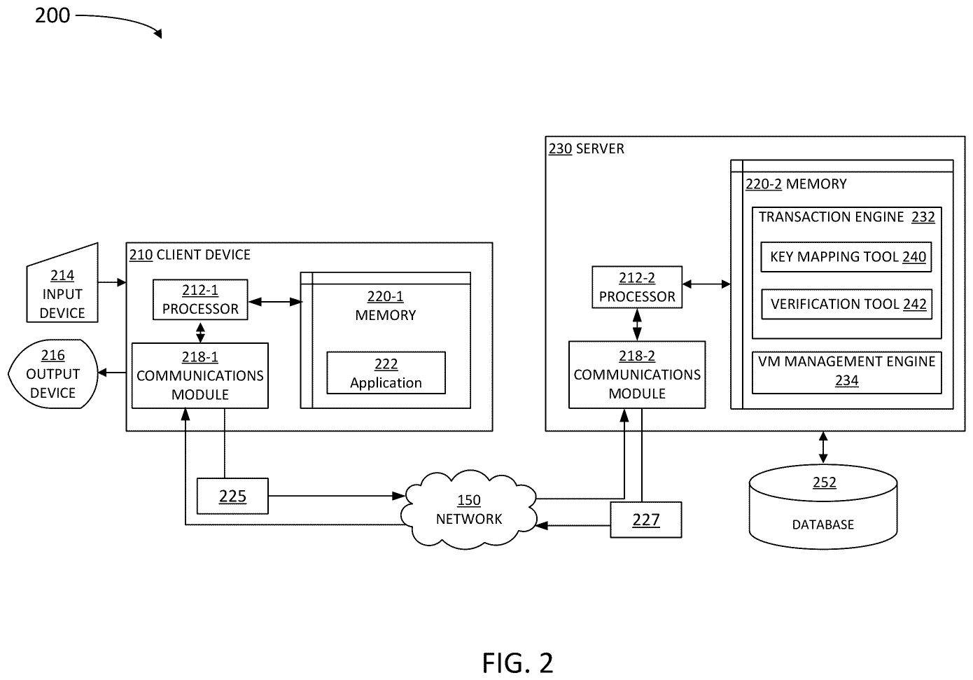

FIG. 2 illustrates a block diagram 200 including some of the devices and systems used in architecture 100, according to some embodiments. Client device 210 and server 230 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). A user may interact with client device 210 via an input device 214 and an output device 216. Input device 214 may include a mouse, a keyboard, a pointer, a touchscreen, a microphone, a joystick, a virtual joystick, and the like. In some embodiments, input device 214 may include cameras, microphones, and sensors, such as touch sensors, acoustic sensors, inertial motion units—IMUs—and other sensors configured to provide input data to a VR/AR headset. Output device 216 may be a screen display, a touchscreen, a speaker, and the like.

Client device 210 may include a memory 220-1 and a processor 212-1. Memory 220-1 may include an application 222 (e.g., a smart contract application), configured to run in client device 210 and couple with input device 214 and output device 216. Application 222 may be downloaded by the user from server 230 and may be hosted by server 230. In some embodiments, client device 210 is a mobile phone used to collect a video or picture and upload to server 230 using a video or image collection application 222, to store in training database 252. In a smart contract application 222, communications module 218-1 transmits a contract party signature 225 to server 230 for inclusion in a smart contract 227. Smart contract 227 is transmitted via communications module 218-2 from server 230 to all parties of the smart contract. Accordingly, smart contract 227 may include one or more signatures from the parties to the contract. More generally, application 222 may include any transactional application that involves a verifiable authority for each of the parties in the transaction.

Server 230 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a transaction engine 232 and a VM management engine 234. Transaction engine 232 may include a key mapping tool 240 and a verification tool 242.

Key mapping tool 240 is configured to handle encrypted keys for authorizing signatures from one or more parties to a transaction handled by application 222. In some embodiments, key mapping tool 240 creates generic, low-level key-value stores that implements fully non-custodial applications where users that claim root keys are the only ones that can modify application states. Some exemplary application data formats where the user is the only entity that controls data may include byte strings as simple as: [my name]/[application] _[data-record]. In some embodiments, key mapping tool 240 may connect a chain of files by their hashes to establish a “feed” off a single value to power a decentralized “feed.” Accordingly, a key-value store only needs to store the “tip” of the chain in state, as the rest of the hashes can be determined by walking back from the tip. In some embodiments, key mapping tool 240 implements an inter-planetary name system (IPNS) to dynamically generate/append values to a given “content address.” This results in faster replication than IPFS, which enforces content address and complicates connection to the most recent data with just a user-specified prefix/key.

Verification tool 242 is configured to verify the signatures (e.g., in datasets 225) provided by the multiple parties for a transaction using encrypted keys mapped by key mapping tool 240. In some embodiments, verification tool 242 implements a PoW to determine the validity of a transaction given a certain amount of network congestion (the more congestion, the more work required to be valid).

Transaction engine 232 may share or provide a dataset 227 to multiple parties in a transaction, after receiving and verifying signatures 225. Parties in the transaction may access transaction engine 232 through application 222, installed in memory 220-1. Accordingly, application 222 may be installed by server 230 and perform scripts and other routines provided by server 230 through any one of multiple tools. Execution of application 222 may be controlled by processor 212-1. In some embodiments, transaction engine 232, the tools contained therein, and at least part of training database 252 may be hosted in a different server that is accessible by server 230 or client device 210.

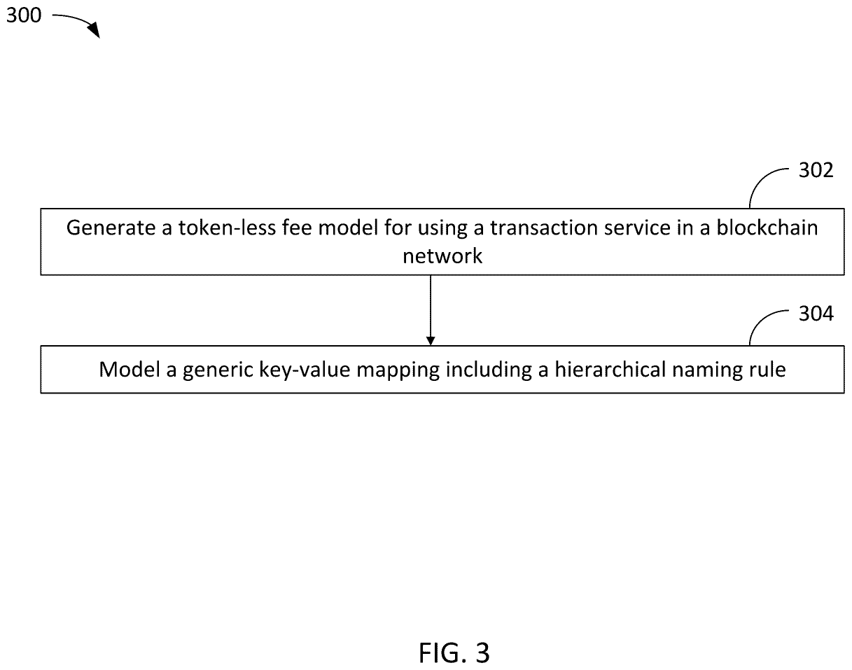

FIG. 3 is a flow chart illustrating steps in a method 300 for implementing a key-value mapping virtual machine, according to some embodiments. In some embodiments, at least one or more steps in method 300 may be performed by a processor executing instructions stored in a memory, either in a client device, in a server or virtual machine, or in a database, as disclosed herein (cf. processors 212, memories 220, client devices 110 and 210, servers 130 and 230, and databases 152 and 252). The client devices, servers, VMs, and databases may be communicatively coupled with one another via communications modules, through a network (e.g., communications modules 218 and network 150). In some embodiments, the memory may include a transaction engine and a VM management engine, including tools such as a key mapping tool or a verification tool, as disclosed herein (cf. transaction engine 232, VM management engine 234, key mapping tool 240, and verification tool 242). In some embodiments, methods consistent with the present disclosure may include at least one or more of the steps in method 300 performed in a different order, simultaneously, quasi simultaneously, or overlapping in time.

Step 302 includes generating a token-less fee model that advocates a healthy use of the service. In some embodiments, step 302 is part of a state transition logic and can be applied to a modified version of an existing VM. In some embodiments, step 302 includes limiting the amount of workload induced by users' transactions to achieve a similar goal to other blockchains and/or VMs and limiting the dynamic resource utilization of a network. In some embodiments, step 302 includes generating PoWs for each fee-less transaction (e.g., token-less). In some embodiments, step 302 includes selecting a PoW. Accordingly, in some embodiments, step 302 includes keeping a recent block hash to avoid a mining conflict. Mining conflicts are undesirable because they increase complexity leading to a few sophisticated parties monopolizing the blockchain network. In some embodiments, step 302 includes using an ASIC-resistant mining to avoid ASIC dominance/participation.

Step 304 includes modeling a generic key-value mapping. In some embodiments, step 304 includes allowing a hierarchical naming rule. For example, in some embodiments, step 304 may include subdividing each “key” into multiple levels (e.g., a pathname in an OS, where the component from each level acts like a directory). In some embodiments, step 304 includes attributing key ownership (e.g., a permission to alter the key value) based on the hierarchy. For example, in some embodiments, step 304 includes allowing the creator of some directory to manipulate all contents under the directory.

When a user who wants to manipulate the key-value state (introducing new mapping or changing the existing content), step 304 may include receiving, form the user, a transaction request which contains a block hash referring to a block in the recent past (e.g., 1 minute). This limits the ability to pre-generate work to monopolize or destabilize the system. Also, in some embodiments, step 304 may include receiving, form the user, some fix-length integer known as “graffiti” (or “nonce,” e.g., Bitcoin). The graffiti value is used as part of a PoW process to validate the transaction. Accordingly, step 304 may include performing a controllable amount of computational power to validate the transaction. The degree of complexity to generate a PoW is determined by the system load. In some embodiments, step 304 includes deterministically deriving the degree of complexity of a PoW from a rolling window of the current congestion of the network. In some embodiments, step 304 may also include determining a block-based work overhead to be met when blocks are generated faster than a target block rate. In some embodiments, step 304 includes offloading a key value for storage in an IPFS and enabling indexing of larger files.

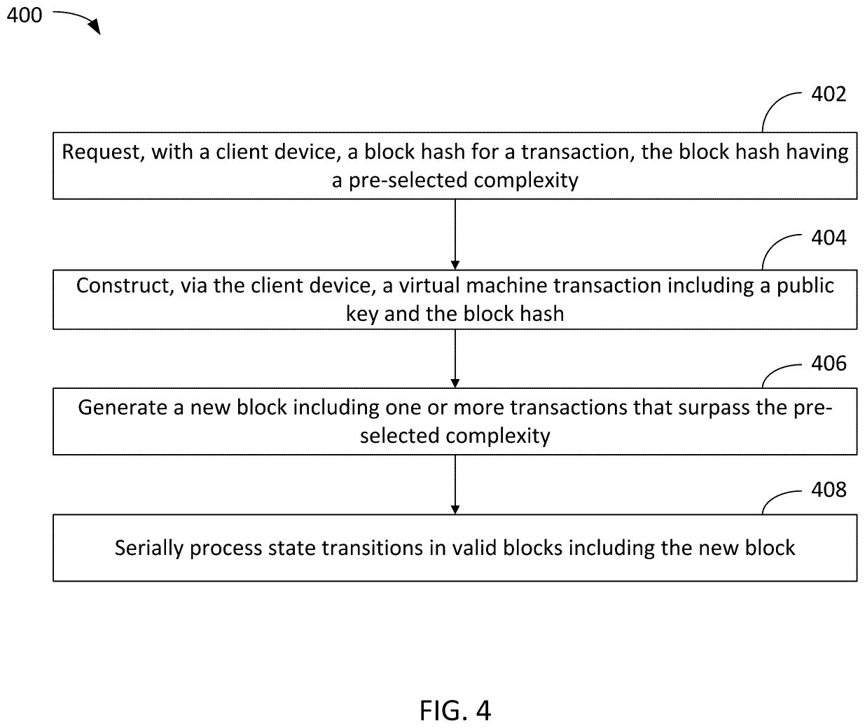

FIG. 4 is a flow chart illustrating steps in a method 400 for implementing a token-less and key-value mapping virtual machine, according to some embodiments. In some embodiments, at least one or more steps in method 400 may be performed by a processor executing instructions stored in a memory, either in a client device, in a server or virtual machine, or in a database, as disclosed herein (cf. processors 212, memories 220, client devices 110 and 210, servers 130 and 230, and databases 152 and 252). The client devices, servers, VMs, and databases may be communicatively coupled with one another via communications modules, through a network (e.g., communications modules 218 and network 150). In some embodiments, the memory may include a transaction engine and a VM management engine, including tools such as a key mapping tool or a verification tool, as disclosed herein (cf. transaction engine 232, VM management engine 234, key mapping tool 240, and verification tool 242). In some embodiments, methods consistent with the present disclosure may include at least one or more of the steps in method 400 performed in a different order, simultaneously, quasi simultaneously, or overlapping in time.

Step 402 includes requesting, with a client device, a block hash for a transaction, the block hash having a pre-selected complexity. In some embodiments, step 402 further includes directing a node in a blockchain network to compute the block hash. In some embodiments, step 402 includes sampling a pre-selected number of recent blocks to find the block hash for the transaction. In some embodiments, step 402 includes iteratively modifying a proof of work request threshold until the block hash has a complexity that surpasses the pre-selected complexity or a time limit for the block hash has lapsed.

Step 404 includes constructing a virtual machine transaction including a public key and the block hash. In some embodiments, step 404 includes storing the transaction in a blockchain database. In some embodiments, step 404 includes sorting a transaction list in the database by a degree of complexity of each transaction.

Step 406 includes generating a block including one or more transactions that surpass the pre-selected complexity. In some embodiments, step 406 includes verifying that a sum of a difference between the complexity of the one or more transactions and the pre-selected complexity surpasses the pre-selected complexity. In some embodiments, the pre-selected complexity is a fixed surcharge of a desirable complexity for a block hash wherein all transactions surpass a minimum complexity. In some embodiments, step 406 includes increasing the pre-selected complexity when a block generation rate surpasses a target rate and reducing the pre-selected complexity when the block generation rate is lower than the target rate. In some embodiments, the target rate for block generation is one block created within one (1) and two (2) seconds.

Step 408 includes serially processing state transitions in a valid block. In some embodiments, step 408 includes prioritizing transactions that include more work. When a prefix has not been used, or the prefix has expired, step 408 includes claiming a prefix. In some embodiments, step 408 includes claiming a prefix up to X bytes, and verifying that the prefix is not the address of a public key. When the user is the public-key holder, step 408 includes allowing the user to use the public-key or a part thereof, as a prefix. In some embodiments, step 408 includes modifying a key in a prefix hierarchy. In some embodiments, step 408 includes verifying that the key to be modified is under a controlled prefix.

In some embodiments, step 408 includes adding a lifespan transaction for a prefix. In some embodiments, prefixes decay over time (1 prefix with no keys lasts 7 days, a prefix with more subkeys decays faster). Accordingly, step 408 may include adding seven (7) days of lifespan to a prefix. In some embodiments, step 408 may include spreading the lifespan across all sub-keys (e.g., 1 day of life with 7 keys in a given hierarchy). In some embodiments, to have a deterministic state at each hierarchy state and enable fast synchronization, a VM as disclosed herein does not delete old prefixes asynchronously. In some embodiments, a user can add lifespan to a prefix without having a key, and the community of users can support the longevity of key and prefix. In some embodiments, step 408 includes verifying that the KVVM contains relevant and valid data and that the degree of complexity makes it prohibitively CPU-intensive for a third-party to bloat the state.

In some embodiments, step 408 may include the following additions: Step 408 may include requesting a multi-signature key ownership of a prefix for decentralized autonomous organization-owned accounts. In some embodiments, step 408 includes a mining competition for popular prefixes/forced lifespan limit to avoid stagnant verification procedures to take over. In some embodiments, step 408 includes stateless execution of new blocks. Accordingly, steps 408 may include requesting a Merkle path for a block that is modified and all keys in the hierarchy. Thus, validators may only store state root hashes. In some embodiments, step 408 includes replicating large files outside of a blockchain state to avoid an external source for large files (e.g., an entire file blob in an IPFS). The above additions to step 408 may be performed repeatedly (in sequence or not), until all new blocks are incorporated and verified in the blockchain.

### Hardware Overview

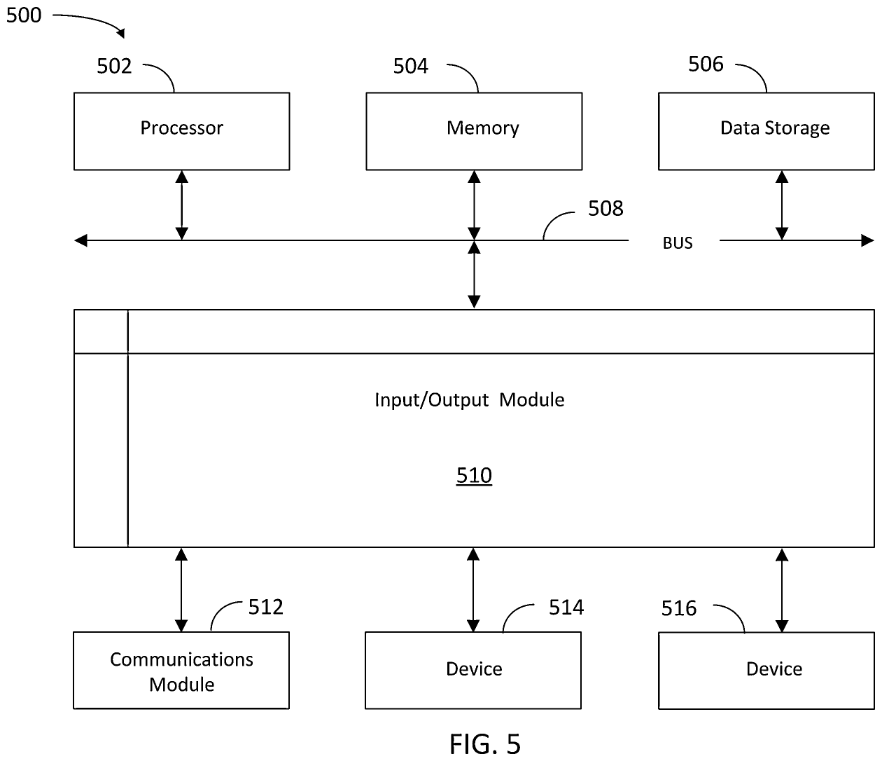

FIG. 5 is a block diagram illustrating an exemplary computer system 500 with which headsets and other client devices 110, and methods 300 and 400 can be implemented, according to some embodiments. In certain aspects, computer system 500 may be implemented using hardware or a combination of software and hardware, either in a dedicated server, or integrated into another entity, or distributed across multiple entities. Computer system 500 may include a desktop computer, a laptop computer, a tablet, a phablet, a smartphone, a feature phone, a server computer, or otherwise. A server computer may be located remotely in a data center or be stored locally.

Computer system 500 includes a bus 508 or other communication mechanism for communicating information, and a processor 502 (e.g., processors 212) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer-readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled with bus 508 for storing information and instructions. Computer system 500 may be coupled via input/output module 510 to various devices. Input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, input/output module 510 is configured to connect to a plurality of devices, such as an input device 514 and/or an output device 516. Exemplary input devices 514 include a keyboard and a pointing device, e.g., a mouse or a trackball, by which a consumer can provide input to the computer system 500. Other kinds of input devices 514 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 516 include display devices, such as an LCD (liquid crystal display) monitor, for displaying information to the consumer.

According to one aspect of the present disclosure, headsets and client devices 110 can be implemented, at least partially, using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that some or all steps, operations, or processes may be performed automatically, without the intervention of a user. Method claims may be provided to present elements of the various steps, operations, or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the included claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A computer-implemented method, comprising:
requesting, with a client device, a block hash for a transaction, the block hash having a pre-selected complexity;
constructing, via the client device, a virtual machine transaction comprising a public key and the block hash; and
generating a new block including one or more transactions that surpass the pre-selected complexity.

2. The computer-implemented method of claim 1, wherein requesting the block hash comprises selecting a node in a blockchain network to compute the block hash.

3. The computer-implemented method of claim 1, wherein requesting the block hash comprises sampling a pre-selected number of recent blocks to find the block hash for the transaction.

4. The computer-implemented method of claim 1, wherein requesting the block hash comprises iteratively modifying a proof of work request threshold until the block hash has a complexity that surpasses the pre-selected complexity.

5. The computer-implemented method of claim 1, wherein requesting the block hash comprises modifying a proof of work request threshold when the block hash has expired.

6. The computer-implemented method of claim 1, wherein constructing a virtual machine transaction comprises storing the virtual machine transaction in a blockchain database.

7. The computer-implemented method of claim 1, wherein constructing a virtual machine translation comprises sorting a transaction list in a blockchain database by a degree of complexity of each virtual machine transaction.

8. The computer-implemented method of claim 1, wherein generating a new block comprises increasing the pre-selected complexity when a block generation rate surpasses a target rate.

9. The computer-implemented method of claim 1, wherein generating a new block comprises reducing the pre-selected complexity when a block generation rate is lower than a target rate.

10. The computer-implemented method of claim 1, wherein generating a new block including one or more transactions comprises verifying that a sum of a difference between a complexity of the one or more transactions and the pre-selected complexity, surpasses the pre-selected complexity.

11. A system, comprising:
a memory storing multiple instructions; and
one or more processors configured to execute the instructions to cause the system to perform a process, comprising:
to request, with a client device, a block hash for a transaction, the block hash having a pre-selected complexity;
to construct, via the client device, a virtual machine transaction comprising a public key and the block hash;
to generate a block including one or more transactions that surpass the pre-selected complexity; and
to serially process state transitions in valid blocks.

12. The system of claim 11, wherein to request the block hash the one or more processors execute instructions to select a node in a blockchain network to compute the block hash.

13. The system of claim 11, wherein to request the block hash the one or more processors execute instructions to sample a pre-selected number of recent blocks to find the block hash for the transaction.

14. The system of claim 11, wherein to request the block hash the one or more processors execute instructions to iteratively modify a proof of work request threshold until the block hash has a complexity that surpasses the pre-selected complexity.

15. The system of claim 11, wherein to request the block hash the one or more processors execute instructions to modify a proof of work request threshold when the block hash has expired.

16. A non-transitory, computer-readable medium that stores instructions which, when executed by one or more processors, cause a computer to perform a method, the method, comprising:
requesting, with a client device, a block hash for a transaction, the block hash having a pre-selected complexity;
constructing, via the client device, a virtual machine transaction comprising a public key and the block hash; and
generating a block including one or more transactions that surpass the pre-selected complexity.

17. The non-transitory, computer readable medium of claim 16, wherein requesting the block hash comprises selecting a node in a blockchain network to compute the block hash.

18. The non-transitory, computer-readable medium of claim 16, wherein requesting the block hash comprises sampling a pre-selected number of recent blocks to find the block hash for the transaction.

19. The non-transitory, computer-readable medium of claim 16, wherein requesting the block hash comprises iteratively modifying a proof of work request threshold until the block hash has a complexity that surpasses the pre-selected complexity.

20. The non-transitory, computer-readable medium of claim 16, wherein requesting the block hash comprises modifying a proof of work request threshold when the block hash has expired.
